(19) United States
(12) Patent Application Publication
(10) Pub. No.: US 2007/0106483 A1
(43) Pub. Date: May 10, 2007

(54) Hybrid hardware/firmware multi-axis accelerometers for pointer control and user interface

(75) Inventors: Robert Kelley, Portland, OR (US); Jonathan Betts-La Croix, San Mateo, CA (US); Richard Pocklington, San Francisco, CA (US); Vince Alcouloumre, Emeryville, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 11/580,236

(22) Filed: Oct. 12, 2006

Related U.S. Application Data
(60) Provisional application No. 60/727,139, filed on Oct. 14, 2005.

(51) Int. Cl. G01P 15/00; G06F 15/00

(52) U.S. Cl. 702/141

(57) ABSTRACT

A portable computing device with hybrid hardware/firmware accelerometers for pointer control and user interface is disclosed. In one embodiment, a portable computing device can include: (i) at least one accelerometer; and (ii) an embedded controller coupled to the accelerometer, where the embedded controller can change a parameter or variable of the portable computing device when a predetermined condition is detected by the accelerometer. The predetermined condition can include a tilt of the portable computing device, and the parameter that is changed can be a game piece property, for example.

### RELATED APPLICATIONS

This application claims the benefit of U.S. Provisional Application No. 60/727,139, filed Oct. 14, 2005 (Attorney Docket No. OQO-108/PROV), which is incorporated herein by reference in its entirety.

This application is also related to U.S. patent application Ser. No. ______, entitled “Hybrid Hardware/Firmware Multi-Axis Accelerometers for Drop Detect and Tumble Detect” (Attorney Docket No. 100127-000800), filed Oct. 12, 2006, which is also incorporated herein by reference in its entirety.

### FIELD OF THE INVENTION

The invention relates generally to drop detection in a portable electronic or computing device using accelerometers, and using the same for user interaction with the portable computing device.

### BACKGROUND

Portable computing devices, such as digital assistants, laptop computers, and cellular telephones, continue to proliferate in the marketplace. Further, such computing devices are becoming increasingly smaller, reaching the size of hand-held devices that can be carried around in a breast pocket, for example. The miniaturization of electronics and storage media, such as hard disks, have made it possible to develop these portable computing devices with functionality even exceeding traditional stationary desktop computers.

However, possible tumbling or falling of these portable devices, perhaps leading to component (e.g., the hard disk) damage, are more likely to occur, as compared to stationary computers. Also, overall device miniaturization has made user interface more difficult as compared to larger, more conventional, computing systems. Accordingly, it is desirable to develop protection mechanisms of hard disk drives and other shock sensitive components, as well as to improve user interface features, in such portable computing devices.

### SUMMARY

In one embodiment, a portable computing device can include: (i) at least one accelerometer; and (ii) an embedded controller coupled to the accelerometer, where the embedded controller can change a parameter or variable of the portable computing device when a predetermined condition is detected by the accelerometer. The predetermined condition can include a tilt of the portable computing device, and the parameter that is changed can be a game piece property, for example.

In one embodiment, a method of controlling a portable computing device can include: (i) entering a motion-based user interface mode; (ii) detecting a tilt direction using at least one accelerometer in the portable computing device; and (iii) modifying a parameter using an embedded controller coupled to the accelerometer.

### BRIEF DESCRIPTION OF THE DRAWINGS

FIG. 1 illustrates an example user and portable computing device arrangement.

FIG. 2 shows an example portable computing device with a single accelerometer in accordance with embodiments of the present invention.

FIG. 3 shows an example portable computing device with multiple accelerometers in accordance with embodiments of the present invention.

FIG. 4 shows the example portable computing device of FIG. 3 in a tumble or free fall state.

FIG. 5 shows a simplified flow diagram of an example portable computing device drop detect method in accordance with embodiments of the present invention.

FIG. 6 shows a simplified flow diagram of an example portable computing device user interface method in accordance with embodiments of the present invention.

### DETAILED DESCRIPTION

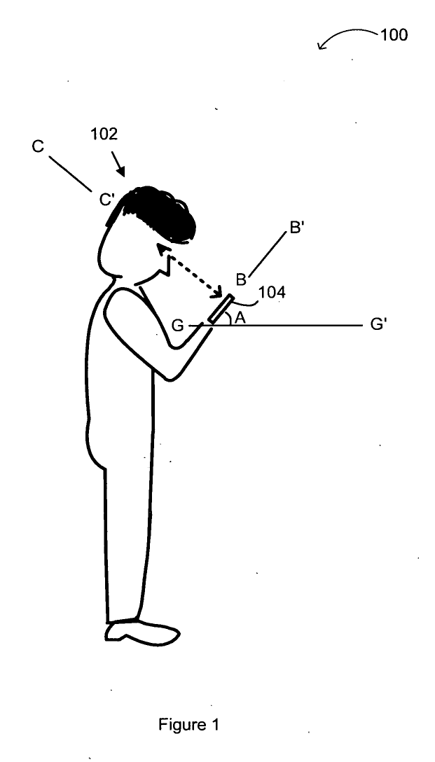

Referring now to FIG. 1, an example user and portable computing device arrangement is indicated by the general reference character 100. Person or user 102 can view portable computing device 104 along the C-C′ axis. Portable computing device 104 can be oriented an angle A from a level G-G′ axis, along the B-B′ axis, for example. User 102 can of course change positions of the device, and may orient portable computing device 104 in any suitable position.

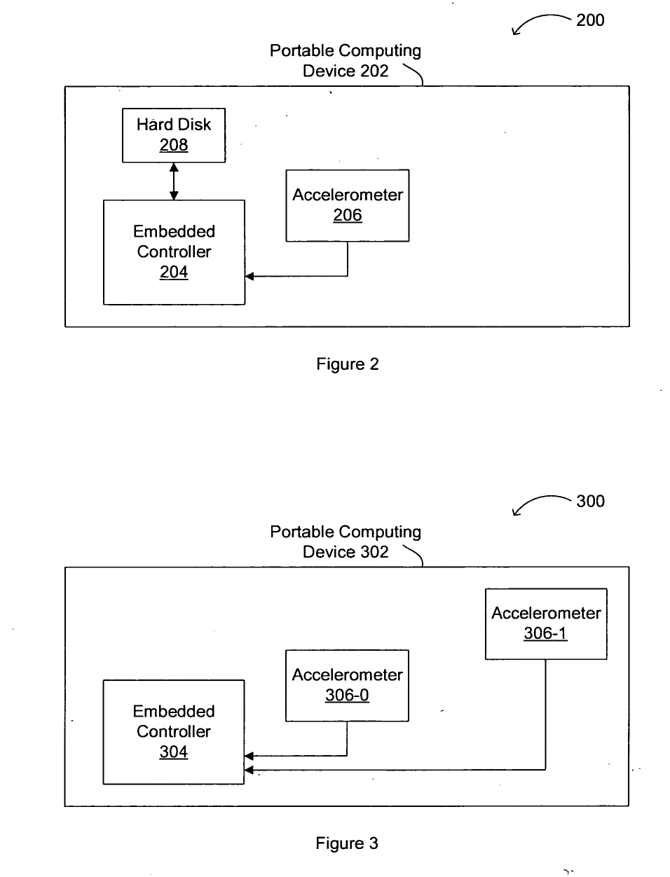

Referring now to FIG. 2, an example portable computing device with a single accelerometer in accordance with embodiments of the present invention is indicated by the general reference character 200. Portable computing device 202 can include service processor or embedded controller 204, and accelerometer 206. Accelerometer 206 may be a 3-axis accelerometer, and may be positioned in a center of mass of portable computing device 202, for example. Alternatively, accelerometer 206 may be positioned near a center of rotational inertia, away from the center of rotational inertia, or in any other suitable position in portable computing device 202.

Embodiments of the present invention can provide a portable computing device with protection mechanisms for shock sensitive components inside the device. For example, hard disk 208 can be turned-off for protection when accelerometer 206 detects a free fall, or otherwise dangerous, situation. In one embodiment, a drop detect method can use one or more accelerometers (e.g., 206) and associated firmware. For example, firmware can include an application running on embedded controller 204. In another embodiment, a method of pointer control and user interface can utilize one or more such accelerometers.

For example, a method of accelerometer calibration or pointer control can include: (i) nullifying x- and y-offsets when portable computing device 202 is oriented flat according to raw measurements; and (ii) nullifying the z-offset when portable computing device 202 is oriented on edge according to raw measurements. This feature can check an offset calibration of a 3-axis accelerometer (e.g., 206), and/or may be used for pointer control as an enhanced user interface, for example.

In one aspect of embodiments, an accelerometer test feature can be included. For example, embedded controller 204 may include a variable called “accelScale” that may typically be set to “0.” When accelScale is 0, the accelerometer test feature may be inactive. However, pressing Fn-Ctl-C (function key, control key, and the letter “C”) can set accelScale to “4,” and may also cause portable computing device 202 to emit a beep. Pressing Fn-Ctl-C again can then set accelScale to “8,” and may result in another beep. Continued such pressing can yield 16, 32, 64, and 128, values for accelScale. Then, pressing Fn-Ctl-C again may set accelScale to “0,” and provide a double beep. When accelScale has a non-zero value, acceleration may be mapped to mouse events. In this fashion, acceleration-based user interface control may be provided.

For example, every 32 ms, accelerometer 206 may be sampled by embedded controller 204, and may thus create mouse events. Further, a frame of reference may be changed to allow natural use in several orientations (i.e., not just one particular orientation, as shown above in FIG. 1). When acceleration-based user interface control mode is enabled, and a display for portable computing device 202 is open, there may be x, y, and z axis control (i.e., “wheel” events). When the display is then closed, the scroll wheel button may be mapped to a left mouse button in order to accommodate one-handed, closed operation, and no wheel events may be allowed. In this case, opening the display again can cancel acceleration-based user interface control mode, for example.

Referring now to FIG. 3, an example portable computing device with multiple accelerometers in accordance with embodiments of the present invention is indicated by the general reference character 300. Portable computing device 302 can include embedded controller 304, as well as multiple accelerometers (e.g., 306-0 and 306-1). At least one of accelerometers 306-0 and 306-1 can be located in a position other than a center of rotational inertia, for example. In this fashion, portable computing device 302 can use multiple accelerometers (e.g., 306-0 and 306-1) to provide a tumble detect mechanism.

If portable computing device 302 falls, but at the same time tumbles rapidly on any of its axes, an accelerometer which is placed anywhere but the center of mass may not read free fall, but instead be fooled by the centrifugal force of the tumbling device. Further, due to constraints in the design process for portable computing device 302, it may not be possible to place an accelerometer precisely at the center of mass. Such accelerometer placement or location constraints may be caused by miniaturization, but may also occur due to thermal design issues, electromagnetic interference (EMI) issues, as well as other issues that may be integral to the device design, for example.

In particular embodiments, multiple accelerometers may be placed in portable computing device 302, such that the accelerometers (e.g., 306-0 and 306-1) may be capable of determining if the device is in free fall, even when the device may be rapidly tumbling along one or more of its axes. If two accelerometers are placed in portable computing device 302 along one of the axes of rotation, one is able to detect spin on any of the other two rotational axes, and can measure free fall if the device tumbles along the rotational axis along which the device is placed.

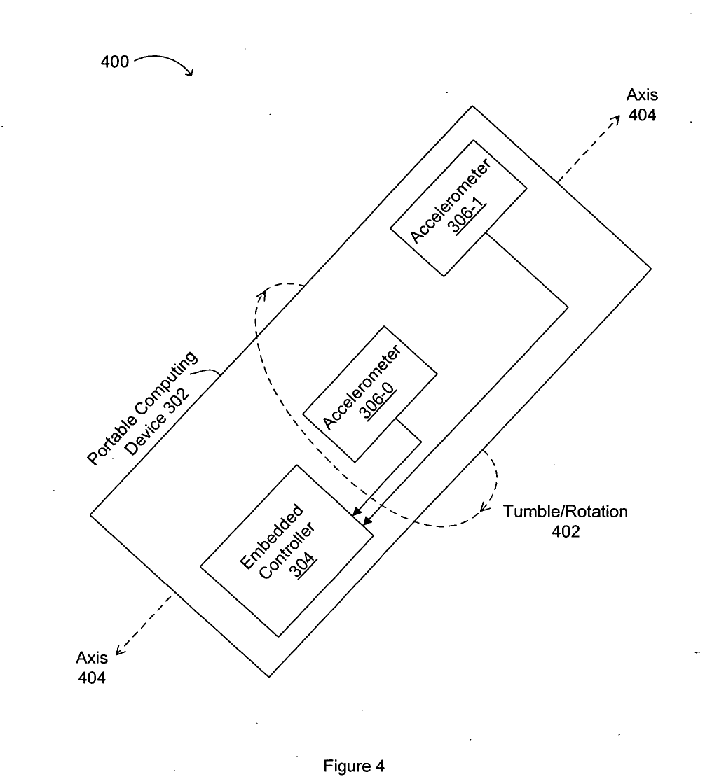

Referring now to FIG. 4, the example portable computing device of FIG. 3 is shown in a tumble or free fall state, and is indicated by the general reference character 400. Tumble/rotation 402 can indicate a rotation about an axis 404. In this particular example, accelerometer 306-1 may not be able to detect spin, but accelerometer 306-0 may be able to detect this action. In general, even if accelerometers 306-0 and 306-1 are “off-axis,” the combination of both accelerometers can still detect free fall because all inertial degrees of freedom may be known. Thus, both rotational and translational acceleration may be known. Accordingly, by each accelerometer providing information to embedded controller 304, an appropriate protection response or change to a protective state can be initiated.

Thus, in specific embodiments, one can measure either rapid tumbling along two axes or free fall along the third axis, regardless of tumbling. Such a set of measurements, rather than a single measurement from a single accelerometer, can be used to trigger a drop detect signal and protect the user's data under a wider range of circumstances, as compared to a conventional drop detect approach.

In some embodiments, such an accelerometer and drop detect calibration application can be used as a balance or level, for example. Further, the accelerometer and drop detect calibration method may also be used for one-handed computer use application. In particular, one-handed computer use can be accommodated when a scroll wheel is mapped to a left-mouse click, for example.

In addition, the accelerometer and drop detect calibration approach in accordance with embodiments of the present invention can be used for games and/or other applications where measurements made from one or more accelerometers may be used to directly impact a game piece. For example, information from one or more accelerometers can be used to directly affect a location of the game piece, to influence game piece momentum, and/or to influence another property or parameter of the game piece (e.g., game piece color, shape, texture, form, or another property of either functional or aesthetic value). In particular, accelerometers in accordance with embodiments can be used in a game piece application in any case where a mouse, slider, or other suitable device, could be used to change a parameter.

Also, one can use the accelerometer and drop detect calibration method in a game or other application where measurements made from an accelerometer may be used to directly impact an application variable. For example, information from one or more accelerometers can be used to directly affect a magnitude of the application variable (e.g., tilt the portable computing device to change a standard “punch” to a strong punch in a game), to influence a rate of change of the variable, to influence a maximum or minimum value of the variable, to modify a function and/or specific parameter defining a variable value, and/or to modify a function determining an effect of the variable upon any number of other variables. Further, such an accelerometer and drop detect calibration application can be used to provide information for one or more variables associated with either one or more applications.

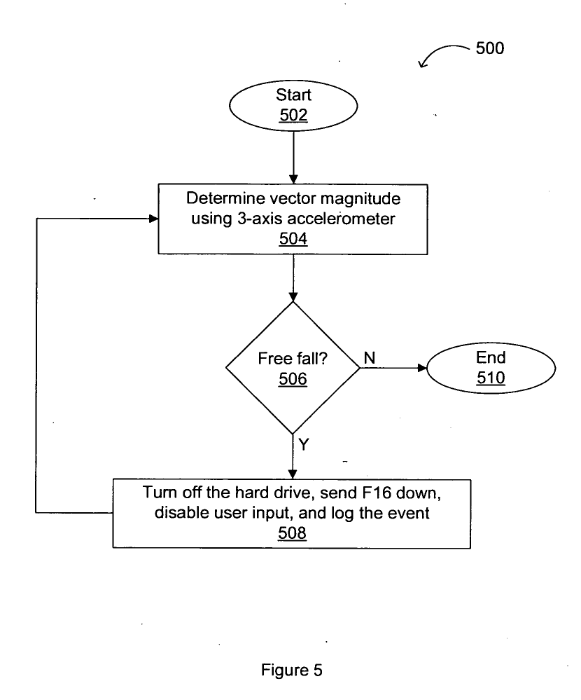

Referring now to FIG. 5, a simplified flow diagram of an example portable computing device drop detect method, in accordance with embodiments of the present invention, is indicated by the general reference character 500. The flow can begin (502) and a vector magnitude can be determined using at least one 3-axis accelerometer (504). If the vector magnitude is such to indicate a situation other than a free fall condition (506), the flow can complete (510). However, if the vector magnitude is such to indicate a free fall condition (506), a protective state, such as by turning off the hard drive, sending “F16” down, disabling user input, and logging the event (508), can be entered. Next, the flow can return to monitoring and determining vector magnitudes using an accelerometer (504).

A more detailed example of such a drop detect method can include: (i) every 8 ms, measure a 3-axis accelerometer and compute a vector magnitude; (ii) if the vector magnitude is less than some threshold for some consecutive number of samples, indicate a free fall state and turn off the hard drive, send F16 down, disable user input, and log the event; and (iii) when the vector magnitude becomes 1g+/− some tolerance for a predetermined consecutive number of samples: (a) if a minimum amount of time has elapsed, restore power to the hard drive; and (b) wait some length of time while the hard drive is enabled and recognized by the operating system (OS), send F16 up, and enable user input.

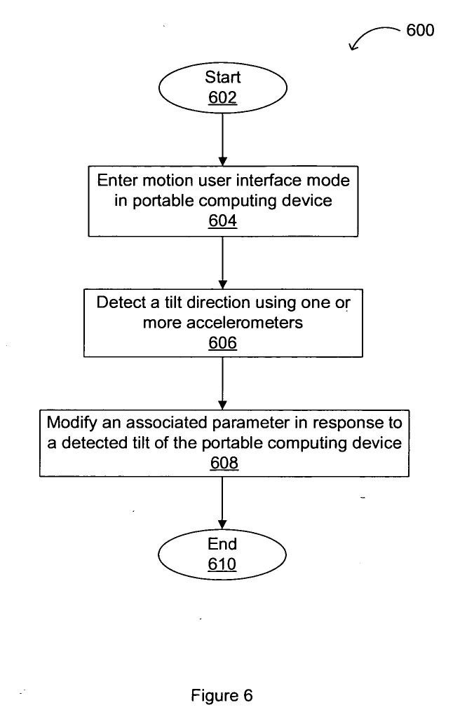

Referring now to FIG. 6, a simplified flow diagram of an example portable computing device user interface method in accordance with embodiments of the present invention is indicated by the general reference character 600. The flow can begin (602) and a motion user interface mode can be entered in the portable computing device (604). A tilt direction can then be detected using one or more accelerometers (606). A parameter, variable, or the like, can then be modified in response to a detected tilt of the portable computing device (608), and the flow can complete (610).

In particular embodiments, an accelerometer and associated firmware layer can act substantially without influence of the operating system. For example, sets of motion can be monitored by one or more accelerometers (e.g., 306-0, 306-1) that then may be able to give commands to an embedded controller (e.g., 304) that may be running a drop detect system or application. Thus, a pattern of flipping, rotating, and/or shaking portable computing device (e.g., 302) can be used to start, reboot, shut down, or otherwise allow a user direct tangible control over power management options of the device, for example. Further, a user may have similar control over any other feature that is controllable by the embedded controller (e.g., 304).

In specific embodiments, the embedded controller, which can run such a drop detect application, may also have control over other features, such as those shown below in Table 1. Further, any of the features of Table 1 may receive input from one or more accelerometers in the portable computing device.

TABLE 1
Feature:

A reference clock
Voltage meters
A photo sensor
Temperature measurements
Measure battery charge, voltage, current and communicate values to OS
Control and measure fan speed
Control backlight
Control the keyboard and keyboard light-emitting diodes (LEDs)
Control trackstick and mouse buttons
Control power button and power indicator LED
Control central processing unit (CPU) startup and shutdown sequence
Write basic input/output system (BIOS) flash during manufacturing
Implement EC loader for loading and upgrading EC firmware
Implement diagnostics in support of manufacturing test
Supply IEEE-1394 media access control (MAC) address
Communicates with the battery
Control transitions between soft off, running, sleeping, etc.
Cock identification
Control scroll wheel and scroll wheel button
Measure and control the battery, battery support chips, and LEDs
Watch POST output from the CPU during boot
Control real time clock
Control the mouse and keyboard interfaces
Cock control for splitbridge, trackstick, tablet, IEEE-1394, AC97 codec

In particular embodiments, accelerometer monitoring firmware may be set to monitor drop detect situations, and to hold a memory of such events. If two such events were to take place in rapid succession while the portable computing device was in a shut down or sleep mode, the embedded controller can send a message to the microprocessor to wake up the device from either an off state or a sleep state, and return to an active state.

In some embodiments, a different pattern of accelerometer motion, or any suitable sequence of portable computing device positions, can be accommodated. For example, positioning a portable computing device that is in a shut down or sleep mode 2s on one side, then 2s flipped upside down, then 2s flipped up again, can cause the embedded controller to send a message to the microprocessor to wake up the device from either an off state or a sleep state. This particular variation can permit the use of a portable computing device in situations where the user may not be willing or able to depress device keys due to physical disability, coverings (e.g., gloves or mitts) restricting digits, and/or other causes of restriction. Further, use of the portable-computing device can thus be permitted in situations where relatively gross physical movement of the device may be used as an interface method.

In one aspect of embodiments of the present invention, accelerometer motion, such as tilting, shaking, flipping, or rotating the portable computing device, can be used to toggle on/off control, alt, function, shift or other keyboard modes or modifier keys, thus allowing a combination of device tilting and keystrokes to accomplish actions traditionally requiring multiple keystrokes. In addition, appropriate sound may also accompany a particular keystroke or set of keystrokes in order to convey that operation to the user. Further, tilting can also be used to scroll a viewable portion of the monitor of the portable computing device such that if a larger area of desktop space was available, the tilting or other suitable motion of the device could be used to relocate the user's view of the desktop.

In particular embodiments, the accelerometer and drop detect calibration application can be used as a pedometer to monitor a number and a pace of small scale accelerometer displacements. Further, such an accelerometer and drop detect calibration application may be used to cause the portable computing device to enter a mode where the device is either more tolerant (e.g., a “jog” mode) or less tolerant (e.g., a “safe” mode) of future drop detect events.

In addition, specific embodiments of the accelerometer and drop detect calibration may be used to monitor a variety of situations that may accordingly warrant changes to the user interface, messages delivered to the user, changes in the state of the drop detect or accelerometer state, size of the font used on the display, or other such features modifiable by the embedded controller used to monitor accelerometers, or other devices or components influenced by the embedded controller. For example, in an environment where substantial swaying or other unsteadiness of the portable computing device position occurs, the device can respond by taking action to increase a readability of the monitor, or an accessibility of the device, such as by slowing down the mouse double click. In this fashion, an unsteady hand of a user can be detected and suitably accommodated.

In particular embodiments, the accelerometer and drop detect calibration application may be used to determine if the portable computing device is being repeatedly shaken. Further, under such circumstances, the firmware may send signals to either shut down power to the device, to open a task manager and close any applications which fail to respond to a test, to automatically reboot the device, or to otherwise interpret the user's device operation in such a way that possibly offending applications and/or operating systems may be reset to conformations amenable to the user, for example. In this fashion, a user can simply shake the portable computing device in order to reset the device.

Although specific embodiments of the invention have been described, variations of such embodiments are possible and are within the scope of the invention. For example, although specific motion examples and detection approaches may be used to describe embodiments herein, other embodiments can use other motions, parameter or variable adjustments, and/or arrangements. Embodiments of the invention can operate among any one or more processes or entities including users, devices, functional systems, and/or combinations of hardware and software.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. For example, distributed, networked systems, components and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A portable computing device, comprising:
at least one accelerometer; and
an embedded controller coupled to the at least one accelerometer, wherein the embedded controller is configured to change a parameter or variable of the portable computing device when a predetermined condition is detected by the at least one accelerometer.

2. The portable computing device of claim 1, wherein the predetermined condition comprises a tilt.

3. The portable computing device of claim 1, wherein the parameter or variable change comprises adjusting a momentum of a game piece.

4. The portable computing device of claim 1, wherein the parameter or variable change comprises influencing a property of a game piece.

5. The portable computing device of claim 1, wherein the embedded controller is further configured to control a sound emission associated with the parameter or variable change.

6. The portable computing device of claim 1, wherein the at least one accelerometer comprises a 3-axis accelerometer.

7. The portable computing device of claim 1, wherein the at least one accelerometer is located away from a center of mass.

8. The portable computing device of claim 1, further comprising a plurality of parameter or variable changes, each corresponding to a different tilt position.

9. The portable computing device of claim 8, wherein each of the plurality of parameter or variable changes comprises a function of a modifier key.

10. The portable computing device of claim 1, wherein the embedded controller is configured to support firmware.

11. A method of controlling a portable computing device, the method comprising:
entering a motion-based user interface mode;
detecting a tilt direction using at least one accelerometer in the portable computing device; and
modifying a parameter using an embedded controller coupled to the at least one accelerometer.

12. The method of claim 11, wherein the entering the motion-based user interface mode comprises using a test feature.

13. The method of claim 11, wherein the modifying the parameter comprises adjusting a momentum of a game piece.

14. The method of claim 11, wherein the modifying the parameter comprises influencing a property of a game piece.

15. The method of claim 11, further comprising emitting a sound to indicate the modifying of the parameter.

16. The method of claim 11, wherein the parameter corresponds to a function of a modifier key.

17. The method of claim 11, wherein the modifying the parameter comprises performing a mouse function.

18. The method of claim 11, wherein the modifying the parameter comprises varying a rate of change of a variable.

19. The method of claim 11, wherein the modifying the parameter comprises changing a minimum or a maximum value of a variable.

20. A means for controlling a portable computing device, the means comprising:
means for entering a motion-based user interface mode;
means for detecting a tilt direction using at least one accelerometer in the portable computing device; and
means for modifying a parameter using an embedded controller coupled to the at least one accelerometer.
